(19) United States
(12) Patent Application Publication
(10) Pub. No.: US 2013/0327548 A1
(43) Pub. Date: Dec. 12, 2013

(54) FIRE-PROTECTION STORAGE MEANS, A VEHICLE, AND A METHOD

(71) Applicant: Eurocopter, (US)

(72) Inventor: Vincent Cailly, Marignane (FR)

(73) Assignee: EUROCOPTER, Marignane (FR)

(21) Appl. No.: 13/654,658

(22) Filed: Oct. 18, 2012

(30) Foreign Application Priority Data
Oct. 27, 2011 (FR) 11 03272

(51) Int. Cl. A62C 3/07; A62C 2/06

(52) U.S. Cl. CPC A62C 3/07; A62C 2/06
USPC 169/43; 169/62

(57) ABSTRACT

The present invention relates to fire-protection storage means (10) having a fire-protection bag (20) suitable for being fastened to a partition (9) of a hold (5) of a vehicle (1). Said fire-protection bag (20) is provided with airtight closure means (30), the fire-protection bag (20) having a vacuum pump (40) and extinguisher means (50) for extinguishing a fire that occurs in the interior (INT) of said fire-protection bag (20).

### CROSS REFERENCE TO RELATED APPLICATIONS

This application claims priority to French patent application No. FR 11 03272 filed on Oct. 27, 2011, the disclosure of which is incorporated in its entirety by reference herein.

### BACKGROUND OF THE INVENTION

(1) Field of the Invention

The present invention relates to fire-protection storage means, to a vehicle provided with such storage means, and to a method.

The invention relates to the general technical field of transporting freight in a hold of a vehicle, and more particularly of an aircraft. The term “vehicle” should be understood as meaning any type of transport means such as a truck, a car, a train, a boat, or an aircraft. The aircraft may have a fixed wing and/or a rotary wing, such as a rotorcraft, helicopter, hybrid helicopter, or any other type of aircraft.

The present description refers more particularly to aircraft, however the invention is not limited in any way to such a particular application.

(2) Description of Related Art

Managing payloads on board aircraft is of great importance, both in economic terms and in terms of the level of safety of aircraft in flight. Efforts are constantly being made to maximize payloads while improving safety in flight, or in general during a mission carried out by a vehicle transporting freight.

In order to ensure safety in flight for an aircraft, it is necessary to prevent payloads from moving so as to avoid any undesirable movement of payloads during a flight. Furthermore, keeping payloads stationary in a predefined arrangement generally makes it possible to ensure both a degree of weight balancing in the distribution of payloads and an acceptable location for the center of gravity of the loaded aircraft.

In the field of aviation, and in particular in aircraft of large size, it is possible to arrange payloads on pallets that are fastened to rails.

It is also possible to envisage preventing payloads from moving with the help of storage means of the barrier net type.

Each barrier net is then releasably fastened by at least one fastener means to attachment points of the vehicle.

The barrier net may be arranged in a substantially vertical plane so as to compartmentalize an inside space of the vehicle, or in a substantially horizontal plane so as to press the payloads against a floor.

Furthermore, it should be observed that the hold of an aircraft, and for example the hold of a rotorcraft, is provided with means for combating fire.

Such means are known to include fire-protection partitions separating the hold from other portions of the aircraft, for example. Such partitions may in particular prevent access to the hold in flight.

Fire-protection devices are also known that include a circuit for monitoring the hold, which circuits cooperate with warning means.

When the monitoring circuit detects a fire, the crew of the aircraft is warned by the warning means, such as visible or audible warning means. The crew can then activate extinguishers present in the hold.

It is thus possible to confine a fire in the hold and/or to extinguish a fire in such a hold.

Nevertheless, it should be observed that in spite of being confined or extinguished, the fire may give rise to an increase of temperature in the hold that is likely to damage sensitive electronic equipment present in the hold.

Furthermore, in order to avoid damaging baggage stored in a hold, use is sometimes made of extinguishers that deliver a gas for inhibiting fire propagation. The gas is not directed to the source of the fire but rather throughout the hold, and that can reduce the rapidity of its action. Furthermore, the hold is soiled by the gas.

The state of the art includes document U.S. 2006/0207773.

That document U.S. 2006/0207773 describes a device making use of a net and a blanket. The blanket is provided with a flexible sheet and a layer made of intumescent material.

A tube serves optionally to convey extinguisher means.

Document U.S. 2008/0290094 describes a fire-protection bag for storing electronic equipment.

Document U.S. Pat. No. 2,472,623 is remote from the technical field of the invention and seeks to keep the content of a bag in position during transport.

### BRIEF SUMMARY OF THE INVENTION

An object of the present invention is thus to propose innovative storage means capable of combating a fire that has occurred in baggage.

According to the invention, fire-protection storage means are provided with a fire-protection bag suitable for being fastened to a partition of a hold of a vehicle, and more particularly of an aircraft such as a rotary wing aircraft.

The term “partition” is used to mean any vertical or horizontal element defining a hold, for example, a strong frame associated with an element occupying a surface area, or indeed a floor.

The storage means are remarkable in particular in that the fire-protection bag is provided with airtight closure means, the fire-protection bag having a vacuum pump and extinguisher means for extinguishing a fire that occurs in the interior of the fire-protection bag.

The invention thus proposes putting baggage in an airtight fire-protection bag and evacuating the inside of the fire-protection bag with the vacuum pump. Consequently, the volume of air contained in the fire-protection bag is minimized.

The term “baggage” is used for convenience to cover baggage as such and also any element that might be stored in the hold. By way of example, the term “baggage” may include cans containing a fluid such as fuel, electrical and electronic equipment, and consequently high-risk elements that might give rise to a fire.

It should also be observed that by evacuating the air present in the fire-protection bag, the pieces of baggage stored in the fire-protection bag tend to be pressed against one another.

In the absence of a large amount of air, any risk of a fire occurring in the stored baggage is minimized. Furthermore, if a fire does occur inside the fire-protection bag, the extent to which the fire develops remains limited insofar as the fire-protection bag contains little air. The fire is also not fed with new air coming from outside the fire-protection bag since the fire-protection bag is closed in airtight manner by the airtight closure means.

Under such circumstances, the temperature that exists inside the fire-protection bag and thus inside the hold is minimized. The impact of the fire on the operation of electronic equipment present in the hold is thus also minimized.

Furthermore, the fire can be extinguished with the help of the extinguisher means so as to avoid the fire propagating to other elements of the hold.

The resulting storage means thus serve to optimize safety in the hold of the vehicle by handling the specific problem of a baggage fire.

It can be understood that the storage means may optionally serve to minimize hold fire-protection partitions, thereby giving rise to savings in terms of weight and cost.

Furthermore, the storage means may optimize baggage retention by virtue of a vacuum being established in the fire-protection bag.

In addition, the extinguisher means act in a restricted and targeted space, i.e. the space defined by the fire-protection bag. Under such circumstances, the invention makes it possible to optimize the extinguishing function as such, and it is possible to minimize the volume of fluid that is used for extinguishing the fire. It can also be understood that items situated outside the fire-protection bag are not soiled by the extinguisher means.

The storage means may also include one or more of the following additional characteristics.

For example, said fire-protection bag may include fastener means for fastening to a partition of a hold. By way of example, such fastener means may comprise a plurality of conventional fastener means for fastening to one or more partitions.

The baggage is thus held in the fire-protection bag with the fire-protection bag being held against at least one partition of a hold by the fastener means.

In another aspect, the fire-protection storage means optionally include warning means for warning a crew about the presence of a fire in the fire-protection bag.

The crew that has been warned then carefully monitors how the situation in the hold progresses by means of pre-existing monitoring devices, for example.

Furthermore, said extinguisher means may comprise an extinguisher co-operating with fire detector means.

The extinguisher is then activated manually or automatically by detector means on detecting a fire.

In a preferred embodiment, such detector means comprise a member for detecting a temperature inside the fire-protection bag that is greater than or equal to a threshold.

For example, the extinguisher comprises a body containing an extinguishing agent, the body including an outlet orifice closed by a thermal bulb fuse.

Said threshold then corresponds to the temperature at which the bulb melts. Under such circumstances, when the temperature inside the fire-protection bag is greater than or equal to the threshold, the bulb ceases to close the outlet orifice, thereby enabling the extinguishing agent to spread within the evacuated bag.

The extinguishing agent may be a fluid, and in particular carbon dioxide, which then constitutes an extinguishing agent that is not toxic, e.g. as compared with halon, carbon dioxide being suitable for extinguishing a fire by inhibiting progress of the fire.

In another aspect, the fire-protection bag may comprise a plurality of fireproof walls made of a material selected from the category of fireproof materials, two adjacent fireproof walls being connected together by a closure member of said closure means. Each fireproof wall may be made using pieces of fabric such as a glass fiber fabric, which pieces are stitched and/or bonded to one another, for example.

Each fireproof wall is optionally covered in a sealing wall. Such a sealing wall may comprise an elastomer or a silicone-based material coated on a fireproof wall in order to make it airtight.

The fire-protection bag may include a bottom fireproof wall secured to a side fireproof wall, the fire-protection bag having a top fireproof wall that may be releasably fastened to the side fireproof wall with the help of the closure means.

Such closure means may comprise at least one closure member having a magnetized tape. For example, the magnetized tape may be of the type used for refrigerator doors.

Furthermore, in one embodiment, the vacuum pump comprises a bellows arranged between an inside surface of the vacuum pump facing the interior of the fire-protection bag and outside surface of the vacuum pump facing the exterior of the fire-protection bag, the outside surface having a handle and an outlet valve, the inside surface including an inlet valve.

A removable cap may close the outlet valve, and straps may hold the bellows in a retracted position.

Thus, an operator can cause the air contained in the fire-protection bag to penetrate into the inside of the bellows by pulling on the handle, with the air passing through the inlet valve. Thereafter, the operator can exhaust the air contained in the bellows by pushing against the handle, with the air passing through the outlet valve.

Optionally, said outside surface includes a connector for connection to a suction device. The connector may coincide with the outlet valve.

In addition to fire-protection storage means, the invention also provides a vehicle including at least one storage means of this type, and in particular an aircraft.

It should be observed that it is possible to provide a hold with one large storage means or else with a plurality of small storage means so as to avoid spoiling all of the baggage in the event of any one extinguisher means being activated.

Finally, the invention provides a method of storing baggage in a hold with the help of storage means of the above-described type, the storage means comprising a fire-protection bag having airtight closure means, the fire-protection bag having a vacuum pump and extinguisher means for extinguishing a fire that occurs in the interior of said fire-protection bag, the method comprising the following steps:

inserting baggage into said fire-protection bag and then closing the fire-protection bag with the help of the closure means;

evacuating the inside of said fire-protection bag with the help of said vacuum pump; and

activating said extinguisher means when a temperature exists inside said fire-protection bag that is greater than or equal to a threshold.

In an embodiment, the crew of the vehicle may be informed about the presence of a fire in a storage means.

### BRIEF DESCRIPTION OF THE SEVERAL VIEWS OF THE DRAWINGS

The invention and its advantages appear in greater detail from the following description of embodiments given by way of illustration and with reference to the accompanying figures, in which:

FIG. 1 is a view of an aircraft;

FIGS. 2 and 3 are views showing storage means;

FIG. 4 is a view showing a vacuum pump and extinguisher means;

FIGS. 5 and 6 are views for clarifying the operation of the vacuum pump; and

FIG. 7 is a view of a variant suitable for connection to a suction device.

Elements that are shown in more than one of the figures are given the same references in each of them.

### DETAILED DESCRIPTION OF THE INVENTION

FIG. 1 shows a vehicle 1 of the aircraft type, and more particularly a rotorcraft. The aircraft 1 has a fuselage defining a front structure 2, a central structure 3, and a rear structure 4, the rear structure 4 including a hold 5.

The hold 5 may be defined by partitions 9 including a floor referred to as the “hold floor 7” for convenience, a power plant floor 8, and strong frames 6.

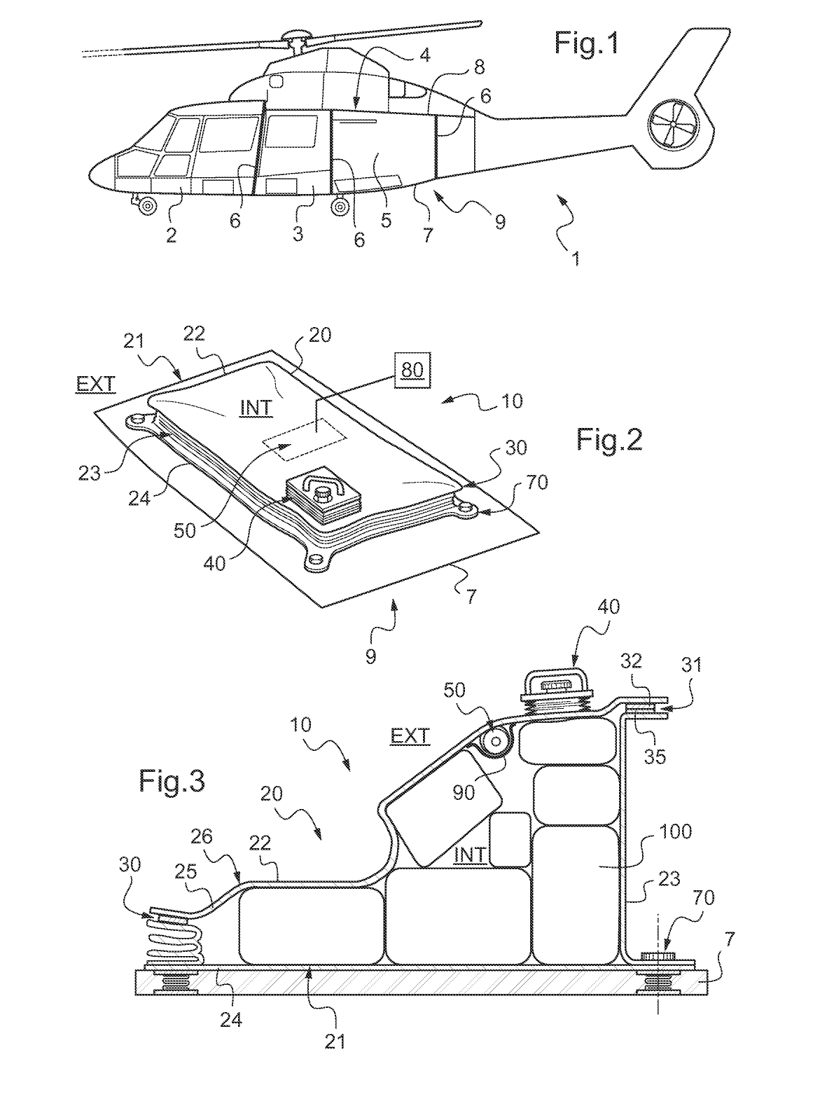

FIG. 2 shows storage means 10 for stowing baggage within a hold.

The storage means 10 comprise a fire-protection bag 20 fastened to the partition, more particularly to the hold floor 7 in the example shown. The fire-protection bag includes at least two fire-protection walls 21 connected together by airtight closure means 30 so as to enable baggage to be inserted in the fire-protection bag.

Furthermore, the storage means 10 include a vacuum pump 40 and extinguisher means 50 suitable for at least inhibiting the development of a fire in the interior INT of the fire-protection bag 20.

Thus, in accordance with the method of implementation of the invention, an operator places the baggage in the fire-protection bag 20 and then closes the fire-protection bag 20 in airtight manner.

The operator then uses the vacuum pump 40 to evacuate the air present in the fire-protection bag 20.

If a fire occurs in the fire-protection bag, then the extinguisher means 50 are activated in order to combat the fire. For example, the extinguisher means may be activated when the temperature that exists inside the fire-protection bag is greater than or equal to a predetermined threshold. Such a threshold may be set at one hundred degrees Celsius, for example.

In another aspect, the storage means may include warning means 80 for reporting that a fire is present inside the fire-protection bag.

The warning means 80 may be triggered by the extinguisher means. For example, activating the extinguisher means may generate a warning that is reported in visual or audible manner by the warning means 80.

FIG. 3 is a section through a fire-protection bag 20 containing baggage 100.

The fire-protection bag 20 comprises a plurality of fireproof walls 21, e.g. comprising a top fireproof wall 22, a side fireproof wall 23, and a bottom fireproof wall 24.

Each fireproof wall 21 may comprise material that withstands fire and/or heat. For example, a fireproof wall 21 may be made using glass fiber fabric.

Furthermore, each fireproof wall may be covered in a sealing wall 26, optionally by being sized with an elastomer or silicone. Any other known sealing material could be used.

Two adjacent fireproof walls may be secured to each other by adhesive and/or heat-sealing, for example. Nevertheless, at least two adjacent fireproof walls are reversibly fastened to each other by airtight closure means 30.

In the embodiment shown, the side fireproof wall 23 and the bottom fireproof wall 24 are secured to each other. In contrast, the top fireproof wall 22 is fastened reversibly to the side fireproof wall 23 by the closure means 30. It is thus possible firstly to separate the top fireproof wall 22 from the side fireproof wall 23 in order to insert the baggage 100 into the interior INT of the fire-protection bag, and also to close the fire-protection bag in airtight manner by fastening the top fireproof wall 22 to the side fireproof wall 23 using the closure means 30.

The closure means 30 may comprise at least one closure member 31 for reversibly connecting together two adjacent fireproof walls.

Such a closure member 31 may comprise a magnetized tape 32 co-operating with a metal portion 33.

It should be observed that the fire-protection bag 20 includes at least one fastener means 70 for fastening it to a partition. Such fastener means 70 may have an eyelet formed in at least one fireproof wall to enable the fire-protection bag to be fastened by conventional means to a partition.

Furthermore, the fire-protection bag may include a fastener member 90 for fastening to extinguisher means 50, e.g. a fastener strap.

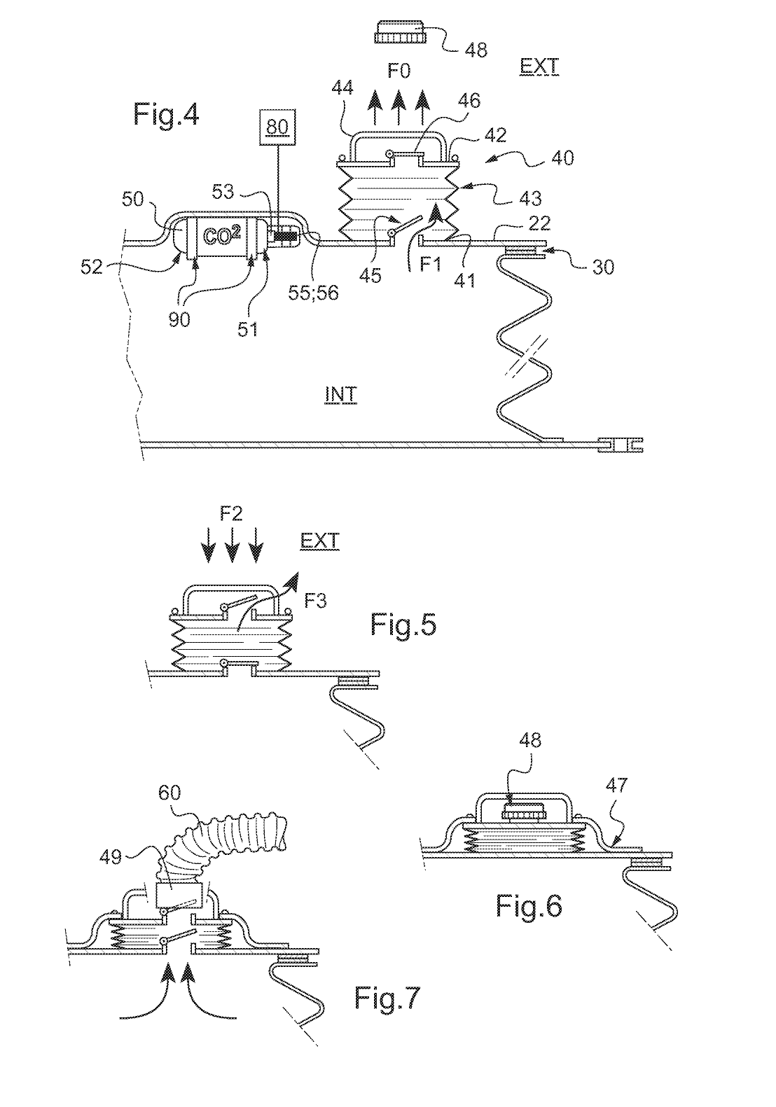

With reference to FIG. 4, the extinguisher means may comprise an extinguisher 51 co-operating with fire detector means 55.

The extinguisher 51 comprises a body 52 storing an extinguishing agent, advantageously carbon dioxide CO₂. The extinguisher is then provided with an outlet orifice 53 enabling the extinguishing agent to spread inside the fire-protection bag 20.

Under such circumstances, the detector means comprise a detector member suitable for detecting that the temperature that exists inside the fire-protection bag 20 is greater than or equal to a threshold. In the embodiment shown, the detector means may be a thermal bulb fuse 56 that melts at said temperature.

The fire-protection bag may also include an incorporated vacuum pump 40.

The vacuum pump 40 may extend in elevation from an inside surface 41 open to the interior of the fire-protection bag 20 towards an outside surface 42 open to the exterior EXT of the fire-protection bag 20, passing via a bellows 43. The inside surface 41 is then secured to the top fireproof wall 22 or coincides with said top fireproof wall 22.

Furthermore, the vacuum pump 40 includes an inlet valve 45 arranged in the inside surface 41, and an outlet valve 46 arranged in the outside surface 42. The outlet valve may be threaded in order to receive a cap 48.

The vacuum pump is also provided with a handle 44 arranged on its outside surface 42.

By pulling on the handle 44 in the direction of arrow FO, an operator can extend the bellows 43. This sucks air out from inside the fire-protection bag 20. This air passes from the interior INT of the fire-protection bag 20 to the vacuum pump 40 through the inlet valve along arrow Fl.

Thereafter, and with reference to FIG. 5, by pushing down the handle 44 along arrow F2, an operator retracts the bellows 43. This causes the air contained in the vacuum pump 40 to be exhausted. This air passes from the vacuum pump 40 to the exterior EXT via the outlet valve along arrow F3.

By operating this vacuum pump repeatedly, it is thus possible to evacuate the inside of the fire-protection bag 20.

With reference to FIG. 6, it is then possible to close the outlet valve using the cap 48, or indeed to maintain the vacuum pump in its retracted position by using straps 47.

With reference to FIG. 7, in an embodiment, the vacuum pump 40 may be provided with a connector 49 for connecting a suction device 60 to the vacuum pump 40. The connector 49 may coincide with the outlet valve, or it may be arranged on the outlet valve.

Naturally, the present invention may be subjected to numerous variations as to its implementation. Although several embodiments are described, it will readily be understood that it is not conceivable to identify exhaustively all possible embodiments. It is naturally possible to envisage replacing any of the means described by equivalent means without going beyond the ambit of the present invention.

What is claimed is:

1. Fire-protection storage means having a fire-protection bag suitable for being fastened to a partition of a hold of a vehicle, wherein said fire-protection bag is provided with airtight closure means, the fire-protection bag having a vacuum pump and extinguisher means for extinguishing a fire that occurs in the interior of said fire-protection bag.

2. Fire-protection storage means according to claim 1, wherein said extinguisher means comprise an extinguisher co-operating with fire detector means.

3. Fire-protection storage means according to claim 2, wherein said detector means comprise a member for detecting a temperature inside said fire-protection bag that is greater than or equal to a threshold.

4. Fire-protection storage means according to claim 2, wherein said extinguisher comprises a body containing an extinguishing agent, said body including an outlet orifice closed by a thermal bulb fuse.

5. Fire-protection storage means according to claim 1, wherein said fire-protection bag comprises a plurality of fireproof walls made of a material selected from the category of fireproof materials, two adjacent fireproof walls being connected together by a closure member of said closure means.

6. Fire-protection storage means according to claim 5, wherein each fireproof wall is covered in a sealing wall.

7. Fire-protection storage means according to claim 1, wherein said closure means comprise at least one closure member having a magnetized tape.

8. Fire-protection storage means according to claim 1, wherein said vacuum pump comprises a bellows arranged between an inside surface facing the interior of the fire-protection bag and outside surface facing the exterior of the fire-protection bag, said outside surface having a handle and an outlet valve, said inside surface including an inlet valve.

9. Fire-protection storage means according to claim 8, wherein said outside surface includes a connector for connection to a suction device.

10. Fire-protection storage means according to claim 1, wherein said fire-protection bag includes fastener means for fastening to a partition of a hold.

11. Fire-protection storage means according to claim 1, wherein said fire-protection storage means include warning means for warning a crew about the presence of a fire in said fire-protection bag.

12. A vehicle, including at least one storage means according to claim 1.

13. A method of storing baggage in a hold with the help of storage means according to claim 1, the storage means comprising a fire-protection bag having airtight closure means, the fire-protection bag having a vacuum pump and extinguisher means for extinguishing a fire that occurs in the interior of said fire-protection bag, the method comprising the following steps:
inserting baggage into said fire-protection bag and then closing the fire-protection bag with the help of the closure means;
evacuating the inside of said fire-protection bag with the help of said vacuum pump; and
activating said extinguisher means when a temperature exists inside said fire-protection bag that is greater than or equal to a threshold.
